(19) United States
(12) Patent Application Publication
(10) Pub. No.: US 2014/0233899 A1
(43) Pub. Date: Aug. 21, 2014

(54) OPTICAL TRUNK CABLE

(71) Applicant: AFL Telecommunications LLC, Duncan, SC (US)

(72) Inventors: Matsuhiro Miyamoto, Greenville, SC (US); Yoshio Hashimoto, Greer, SC (US); Joseph Cignarale, Greer, SC (US)

(73) Assignee: AFL Telecommunications LLC, Duncan, SC (US)

(21) Appl. No.: 14/346,161

(22) PCT Filed: Sep. 21, 2012
(86) PCT No.: PCT/US12/56484

§ 371 Date: Mar. 20, 2014

Related U.S. Application Data
(60) Provisional application No. 61/537,131, filed on Sep. 21, 2011.

(51) Int. Cl. G02B 6/44

(52) U.S. Cl. CPC G02B 6/4401
USPC 385/109; 29/426.1

(57) ABSTRACT

A fiber optic cable comprises a plurality of elongated optical fiber units, each having an outer jacket containing multiple optical fibers. The optical fiber units are interconnected at intermittent bonding locations along an axial length of said trunk cable to form a sheathless bundle. The absence of a sheath makes the trunk cable thinner and lighter than typical trunk cable. In addition, each unit can serve as a horizontal cable at a selected branching location.

### PRIORITY CLAIM

This application is based upon and claims priority to U.S. provisional application Ser. No. 61/537,131, filed Sep. 21, 2011, incorporated herein by reference.

### BACKGROUND OF THE INVENTION

The present invention relates generally to fiber optic cable. More particularly, the present invention relates to an improved optical trunk cable having a plurality of cable units that may be individually branched.

The ability of high-quality optical fiber to transmit large amounts of information without appreciable signal degradation is well known. As a result, optical fibers have found widespread use in many applications, such as voice and data transmission. For example, the need for greater bandwidth in residential settings has brought optical fibers directly into homes and multiple dwelling units (MDUs). Such applications have generally come to be known by the acronym FTTP (“Fiber To The Premises”).

In the case of an MDU, for example, service is typically brought into the building using a trunk cable having a plurality of separately jacketed units. The trunk cable may run vertically through the building, with one or more units necessary to service a particular floor being diverted at the location of that floor. Each of the units contains multiple optical fibers. The trunk cable has a common sheath that surrounds all of the cable units.

The prior art has provided two general types of trunk cable: (1) optical cable for structured wiring; and (2) retractable cable in which a selected unit can be pulled out from the cable sheath at a desired location. In this regard, structured cable is installed with prepositioned loops located in respective junction boxes at each branching floor. To access the fibers inside, the sheath of a loop is cut away. An individual fiber can then be optically joined with a separate horizontal cable in the building.

Because of perceived ease of unit branching, retractable cable has become very popular. Retractable cable has multiple cable units loosely packed inside of a common sheath. The cable units are not stranded (i.e., wound helically) around the central member. When it is desired to branch one of the units at a particular floor, the sheath is cut at the branching position and at a second position higher than the branching position to provide access to the selected unit. The selected unit is then cut at the higher position and pulled through the sheath at the lower, branching position. The branched (or “tail”) portion of the unit can be spliced or otherwise optically joined to different horizontal cable.

As noted, the units of retractable cable are typically loosely packed. This is done intentionally in order to facilitate removal of units from the sheath at a branching position. If the units are too loose, however, they can undesirably move out of the end of the cable due to gravity, vibration or thermal effects. If the units are more tightly packed, they must have higher tensile strength in order to withstand greater pulling force required to remove the tail portion. But, higher tensile strengths can make the cable more expensive, as well as thicker and heavier. In addition, the greater force required to pull the unit out of the sheath requires more effort by the installer. In most retractable cables, the units do not have tensile members such as aramid yarns or steel wire. Buffered fibers with a diameter of 0.9 mm are typically used. So, they are easily degraded (from the standpoint of mechanical reliability) by elongation when pulled out. As noted above, there is a trade-off between tightness and reliability in retractable cables.

Another example of trunk cable for MDU includes pre-fab or pre-terminated cables. These are a kind of bundled cable having units stranded around a central member and bound by string to avoid loosening Each unit is branched at a specified location along the cable and is terminated at the factory. This cable is thus made according to the branching design in a factory. It is very difficult to branch units on demand after installation into the MDU because units are stranded and bound.

The present invention recognizes the foregoing considerations, and others, of the prior art.

### SUMMARY OF THE INVENTION

According to one aspect, the present invention provides an optical trunk cable comprising a plurality of elongated optical fiber units, each of the units having an outer jacket containing a plurality of optical fibers. The optical fiber units are interconnected at intermittent bonding locations along an axial length of the trunk cable to form a sheathless bundle.

In some exemplary embodiments, all of the optical fiber units are interconnected at each of the bonding locations. Preferably, the bonding locations in such embodiments are spaced apart by a predetermined axial pitch.

According to other embodiments, fewer than all of the optical fiber units are interconnected at the bonding locations. In this regard, a different combination of optical fiber units may be interconnected at adjacent bonding locations. For example, at least two of the optical fiber units are interconnected at each bonding location in a repeating pattern having a predetermined axial pitch.

Various bonding techniques are contemplated by the present invention. For example, the optical fiber units may be interconnected via adhesive applied at the bonding locations. Alternatively, the optical fiber units may be interconnected via polymeric material molded in place at the bonding locations. According to another technique, the outer jackets of the optical fiber units may be thermally bonded together at the bonding locations.

Another aspect of the present invention provides a method of branching a selected optical fiber unit from an optical trunk cable. According to one step of the method, an optical trunk cable is provided comprising a plurality of elongated optical fiber units that are interconnected at intermittent bonding locations along an axial length of the trunk cable to form a sheathless bundle. Another step of the method involves selecting a desired branching position along the axial length of the optical trunk cable. A selected optical fiber unit is cut at a cut position spaced apart from the desired branching location to form a tail portion. The selected optical fiber unit is separated from other optical fiber units to which it is interconnected at any bonding locations between the branching position and the cut position. Then, the tail portion of the selected optical fiber unit is removed from the trunk cable for optical connection to a different optical fiber cable.

According to a further aspect of the present invention, an optical trunk cable comprises at least seven elongated optical fiber units. The optical fiber units are interconnected at intermittent bonding locations along an axial length of the trunk cable to form a sheathless bundle. A different combination of less than all of the optical fiber units are interconnected at adjacent bonding locations in a repeating pattern having a predetermined axial pitch.

A still further aspect of the present invention provides an optical trunk cable comprising at least seven elongated optical fiber units. The optical fiber units are interconnected together at intermittent bonding locations along an axial length of the trunk cable to form a sheathless bundle. All of the optical fiber units are interconnected at adjacent bonding locations separated by a predetermined axial pitch.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a diagrammatic end view of an optical trunk cable in accordance with an embodiment of the present invention;

FIG. 2 is a side elevation of the optical trunk cable shown in FIG. 1;

FIG. 3A is a perspective view of an optical fiber unit of the optical trunk cable of FIG. 1, with layers cut away;

FIG. 3B is another example of an optical fiber unit that may be utilized with embodiments of the present invention;

FIG. 4 is a perspective view of a length of optical trunk cable in accordance with an embodiment of the present invention;

FIGS. 5A and 5B show successive bonding locations in the embodiment of FIG. 4;

FIGS. 6A and 6B show successive bonding locations in accordance with another embodiment of the present invention;

FIGS. 7A through 7D show successive bonding locations in accordance with another embodiment of the present invention;

FIG. 8 is a perspective view of a length of optical trunk cable in accordance with another embodiment of the present invention;

FIG. 9 shows a bonding location in the embodiment of FIG. 8;

FIG. 10 shows bonding of the outer jackets of adjacent optical fiber units at an axial bonding location in accordance with an embodiment of the present invention;

FIGS. 11A and 11B illustrate an alternative arrangement where adjacent units are bouded in a plane and then folded into a cylinder by rolling;

FIG. 12 diagrammatically illustrates branching of optical fiber units from an optical trunk cable in accordance with an embodiment of the present invention;

FIGS. 13A through 13C show various configurations for the bundled cable using different numbers of outer units;

FIGS. 14A and 14B show successive bonding locations in accordance with another embodiment of the present invention;

FIGS. 15A through 15F show successive bonding locations in accordance with another embodiment of the present invention; and

FIGS. 16A and 16B show successive bonding locations in accordance with another embodiment of the present invention.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

Referring now to FIGS. 1 and 2, an optical trunk cable 10 constructed in accordance with the present invention is illustrated. Trunk cable 10 has a plurality of optical fiber units interconnected to form a bundle. In the illustrated embodiment, a total of seven such optical fiber units (respectively indicated at 12-1 through 12-7) are provided. As can be seen, optical fiber unit 12-7 is situated in the middle of the group, with the remaining optical fiber units 12-1 through 12-6 being situated on the outside. All of the optical fiber units preferably extend in parallel with each other along the entire actual length of trunk cable 10.

As described above, trunk cables of the prior art have an outer sheath which must be cut in order to access the optical fiber units contained inside. This often presents difficulties during the branching process. In contrast, trunk cable 10 does not have an outer sheath in which the optical fiber units are contained. This facilitates branching of the optical fiber units as will be described below.

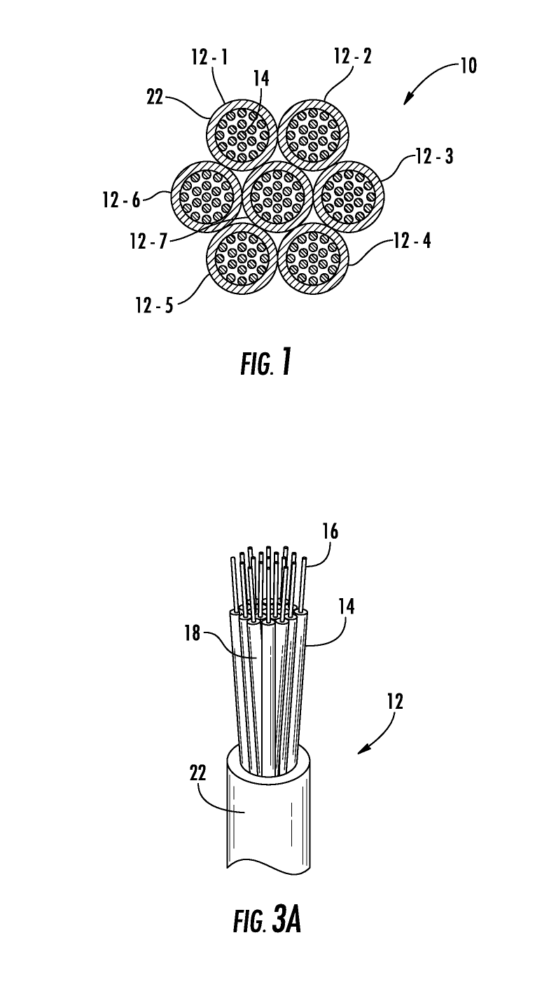

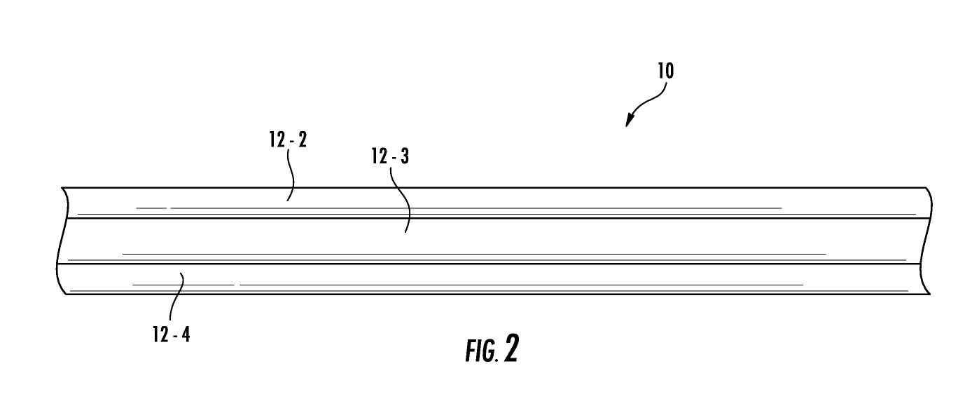

The respective optical fiber units 12 will typically contain a plurality of optical fibers for providing data communication to a corresponding customer. In this regard, FIG. 3A illustrates an optical fiber unit 12 which may be employed in trunk cable 10. As shown, optical fiber unit 12 includes multiple optical fibers 14 extending along its axis. Each of the optical fibers 14 comprises the combination of the optical conductor 16 for transmission of optical signals and its protective sheath 18. Typically, sheath 18 may be formed of a polymer such as PVC. The number of optical fibers 14 within each fiber unit 12 may vary, but typical fiber counts are 4, 6, 12, etc. In addition, each of the fiber units 12 may further include loose aramid filaments that provide strength to optical fiber unit 12. The optical fibers 14 (and aramid filaments) of each fiber units 12 are encased by an outer jacket 22, which may be formed of a suitable material such as plenum-rated PVC, riser-rated PVC or LSZH.

Another example of an optical fiber unit that may be utilized with embodiments of the present invention is shown in FIG. 3B. As shown, unit 12′ includes four optical fibers 14′ (250 μm) in this example jacketed with a high-density polyethylene jacket 22′. Tension members 23a and 23b, such as glass FRP, aramid FRP or steel wire, run alongside the optical fibers. This type of drop cable is widely used in Japan.

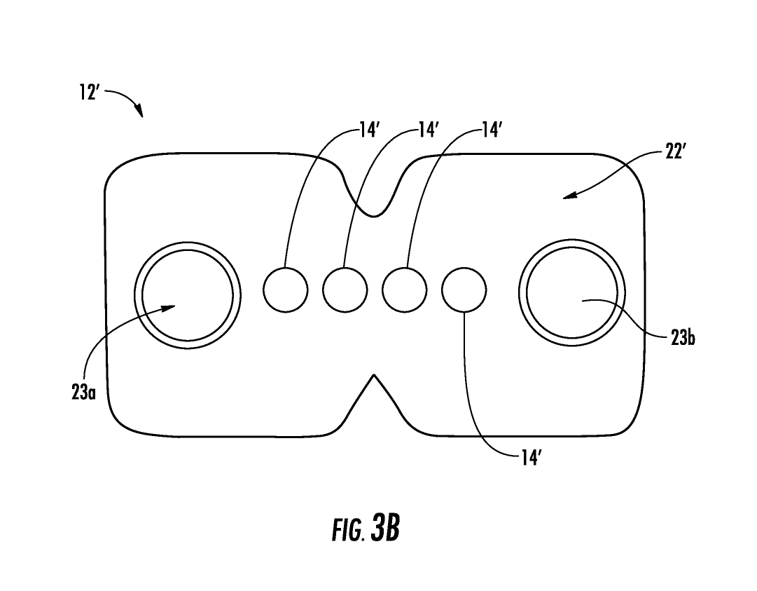

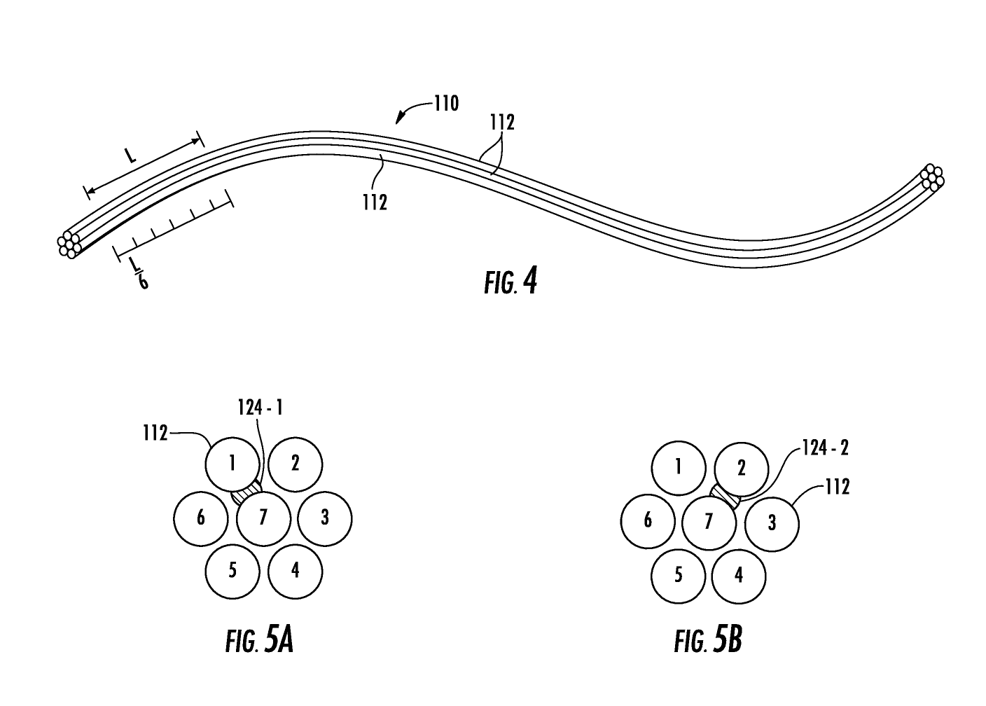

As noted above, fiber optic units comprising trunk cable 10 are attached intermittently at selected bonding locations along the cable length. In this regard, FIG. 4 illustrates a trunk cable 110 constructed in accordance with the present invention. As can be seen, trunk cable 110 includes a plurality of optical fiber units 112. In this example, a total of seven such optical fiber units are provided. The spacing of the bonding locations is chosen to give sufficient integrity to the bundle, while still allowing the bundle to bend easily.

In this embodiment, all of the optical fiber units 112 are not interconnected at the bonding locations. Instead, at each bonding location, one of the outer units is attached to the central (or inner) unit. Preferably, the combination of attached units will vary from one bonding location to the next in a repeating pattern. For example, FIG. 5A shows a first bonding location in which one combination of units (designated 1 and 7) are interconnected (such as by adhesive bond 124-1). At the next bonding location, shown in FIG. 5B, a different combination of units (designated 2 and 7) are interconnected (via adhesive bond 124-2). A third combination of units (e.g., units 3 and 7) could be interconnected at the next bonding location, and so on.

In the case of seven optical fiber units interconnected two at a time in this manner, one skilled in the art will appreciate that the pattern repeats every seventh bonding location. Thus, for a given pitch L, the bonding locations at which two different units would be interconnected is preferably evenly-spaced by a distance L/6. One skilled in the art will appreciate that intermittent bonding of the units allows some free movement between adjacent units. As a result, the bending force that would otherwise be required to bend the bundle is relaxed.

In a typical embodiment, the pitch L could be in the range of two meters to four meters. By way of further explanation, the diameter of each of the optical fibers units making up the trunk cable may typically be in the range of 2 mm to 5 mm. The pitch of intermittent bonding of the units is determined in accordance with stiffness. In other words, the larger in diameter or in stiffness, the larger the pitch. Because of the larger pitch of the bundled cables, there is less convergence of bundled cable and more flexibility for bending. If the stiffness of a constituent unit is less than 40 kgf*mm², the maximum pitch is preferably less than three meters. If the stiffness of a constituent unit is greater than 100 kgf*mm², the maximum pitch is preferably less than six meters. The minimum pitch may be expressed as a function of stiffness T as follows: Pmin=T *1000/90+555 (mm) Maximum pitch may be expressed roughly as a function of unit stiffness: Pmax=T*2000/90+3111 (mm) As mentioned above, longer pitch will give more efficient separation or branching from the bundle (and also results in less cost for bonding).

Tensile strength of each unit is determined in accordance with the requirements of the trunk cable. If each unit is branched and joined with horizontal cable by hand, the requirement of tensile strength in this application may be as follows: 100N for units greater than 2 mm in diameter and 40N for units less than 2 mm in diameter according to Telcordia standard. More or less tensile strength may be desirable for particular situations.

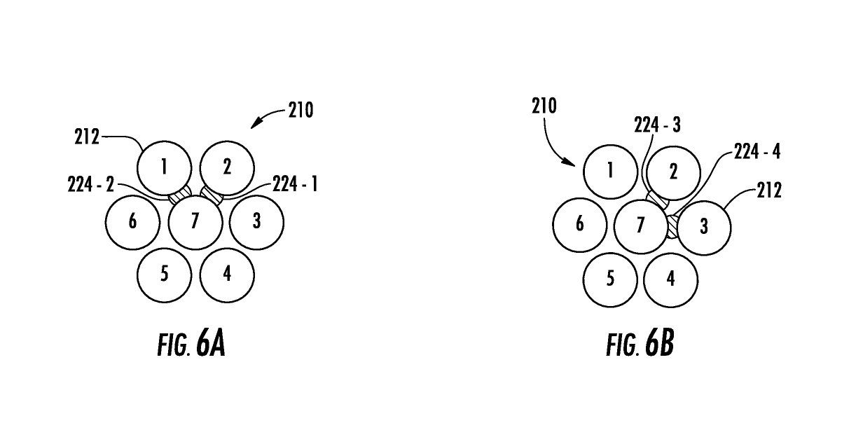

An alternative bonding pattern is diagrammatically illustrated in FIGS. 6A and 6B. In particular, these drawings illustrate a trunk cable 210 comprising units 212. Two adjacent outer units are attached to the inner unit at each bonding location in a repeating pattern. For example, FIG. 6A shows a first bonding location in which units 212 are interconnected in one combination (i.e., 1, 2 and 7) by adhesive bonds 224-1 and 224-2. At the next bonding location, shown in FIG. 6B, a different combination of units (i.e., 2, 3 and 7) are interconnected (via adhesive bonds 224-3 and 224-4). A third combination of units (e.g., units 3, 4 and 7) could be interconnected at the next bonding location, and so on. Like the previous embodiment, this pattern results in six different combinations that repeat at every seventh bonding location. One skilled in the art, however, will appreciate that this embodiment may be stiffer than the previous embodiment.

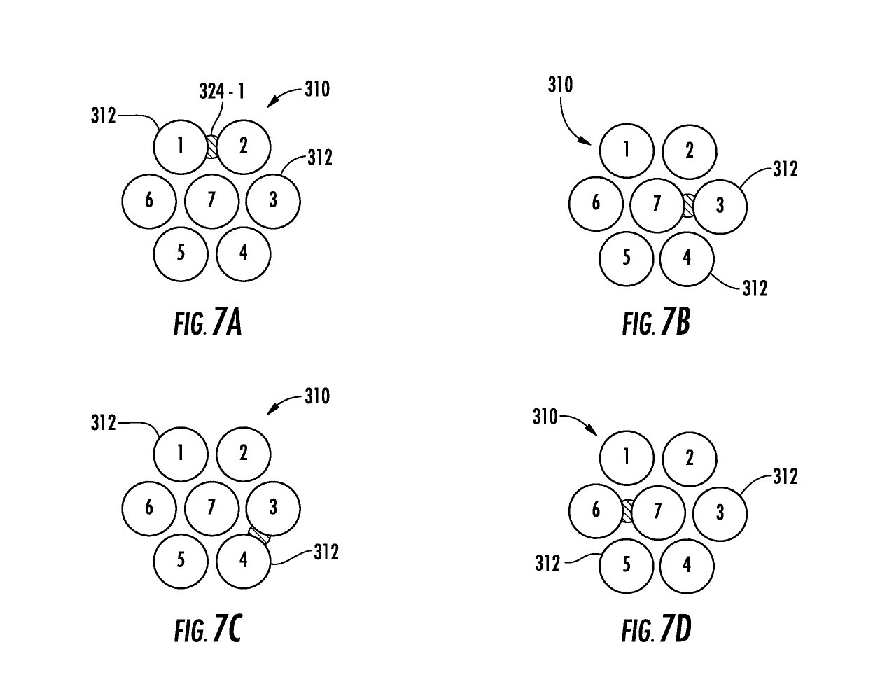

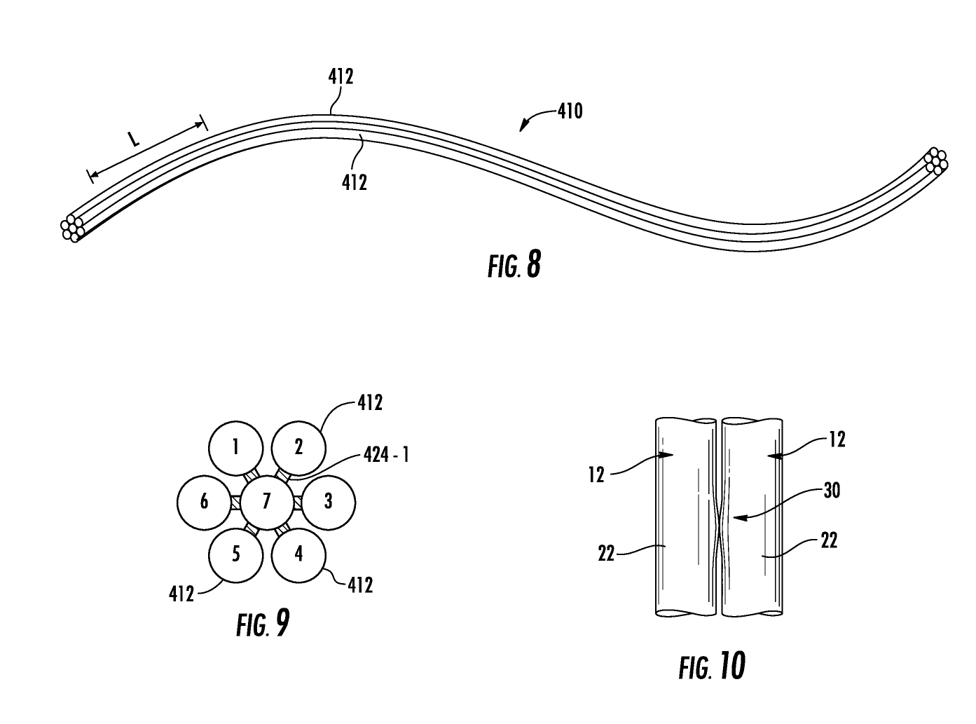

FIGS. 7A through 7D illustrate a trunk cable 310 having a bonding pattern in which a pair of units 312 are interconnected at each bonding location. In particular, a pair of outer units are bonded at every other bonding location. At the intervening bonding locations, an outer unit is bonded to the inner unit. For example, a first bonding location is illustrated in FIG. 7A, where it can be seen that a pair of outer units (designated 1 and 2) are interconnected (by adhesive bond 324-1). At a second bonding location, illustrated in FIG. 7B, one of the outer units (designated 3) is bonded to the inner unit (designated 7). As shown in FIG. 7C, a different pair of outer units (designated 3 and 4) are interconnected at the third bonding location. At the fourth bonding location, another one of the outer units (designated 6) is interconnected with the inner unit. One skilled in the art will appreciate that the pattern continues at successive bonding locations, and then repeats.

FIG. 8 illustrates an optical trunk cable 410 constructed in accordance with another embodiment of the present invention. As shown, trunk cable 410 includes a plurality of optical fiber units 412 arranged in a bundle. Unlike the previous embodiments, however, all of the outer units are interconnected with the inner unit at each bonding location. In this regard, FIG. 9 shows a bonding location at which all of the outer units are interconnected to the inner unit via respective adhesive bonds (such as bond 424-1). Typically, the bonding locations in this embodiment may be more widely spaced than the previous embodiments. For example, the respective bonding locations may be evenly-spaced by pitch L. One skilled in the art will appreciate that this embodiment can be easily produced. In addition, it is believed this embodiment will have good bendability but may be more difficult to bend at the bonding locations than previous embodiments. This is because optical fiber units farther away from the origin of the bend radius will be subjected to elongating tension, whereas units closer to the origin will be under compression.

Whether all or less than all of the units are interconnected at each bonding location, any suitable technique may be utilized to bond the selected units. For example, as shown above, the units may be bonded using a suitable adhesive, such as glue or thermal adhesive. Alternatively, the optical fiber units may be bonded together via polymeric material molded in place at the bonding locations. The molded structure may be configured to be disk-like (encapsulated) or bonding part (edge bonding). Alternatively as indicated at 30 in FIG. 10, the outer jackets 22 of adjacent optical fiber units 12 may be welded using any appropriate method, such as a CO2 laser, fiber laser or other suitable heat source.

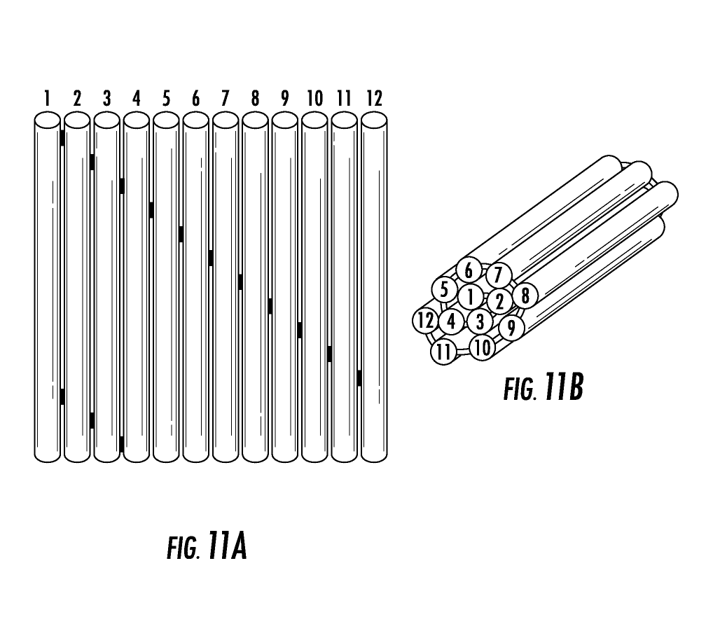

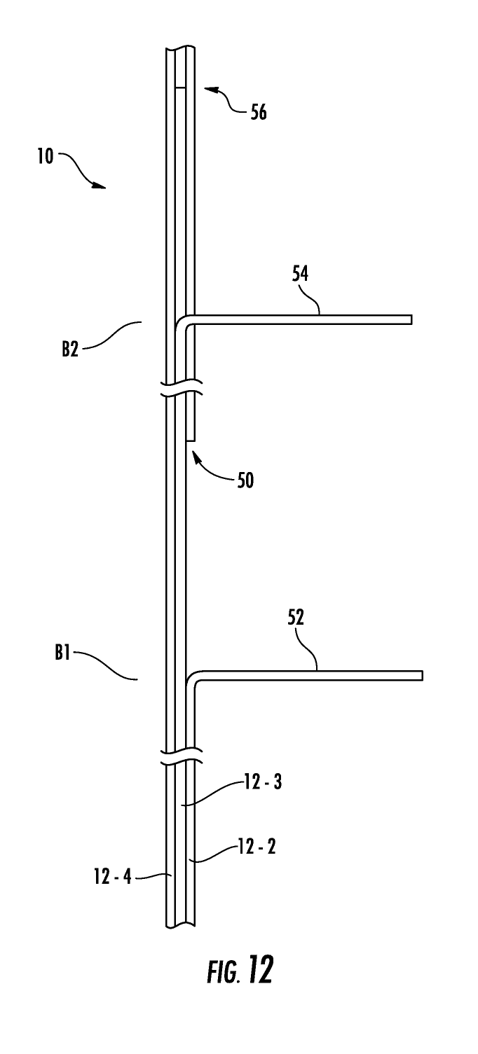

Another example of bonding pattern is shown in FIGS. 11A and 11B. This pattern shows each unit is bonded to the next unit such that all units form a plane (FIG. 11A). This plane is then folded into a cylinder by rolling (FIG. 11B). From the viewpoint of production, it is easy to bond many units intermittently on a flat board.

Referring to FIG. 12, a typical installation of trunk cable 10 is illustrated. In this case, trunk cable 10 is installed vertically in a building having multiple floors. Respective branching positions B1 and B2 correspond to two of the floors. It is desired to separate one optical fiber unit from the bundle at branching position B1 and a second optical fiber unit 12 from the bundle at branching position B2. In particular, optical fiber unit 12-2 is branched at B1 while optical fiber unit 12-3 is branched at B2.

In order to accomplish this, unit 12-2 is cut (as indicated at 50) at a position higher than B1. This provides a tail portion 52 which can be removed from the bundle for optical connection to existing horizontal cable in the building. It will be appreciated that unit 12-2 will need to be separated from any bonding locations between B1 and cut position 50 in order to remove tail position 52. Similarly, a tail portion 54 is created at branch location B2 by cutting optical fiber unit 12-3 at position 56. Any intervening bonds between B2 and position 56 are cut so that tail portion 54 can be removed from the bundle. Depending on the length of tail portion 54, it may serve as horizontal cable as is, without the need to splice to other cable.

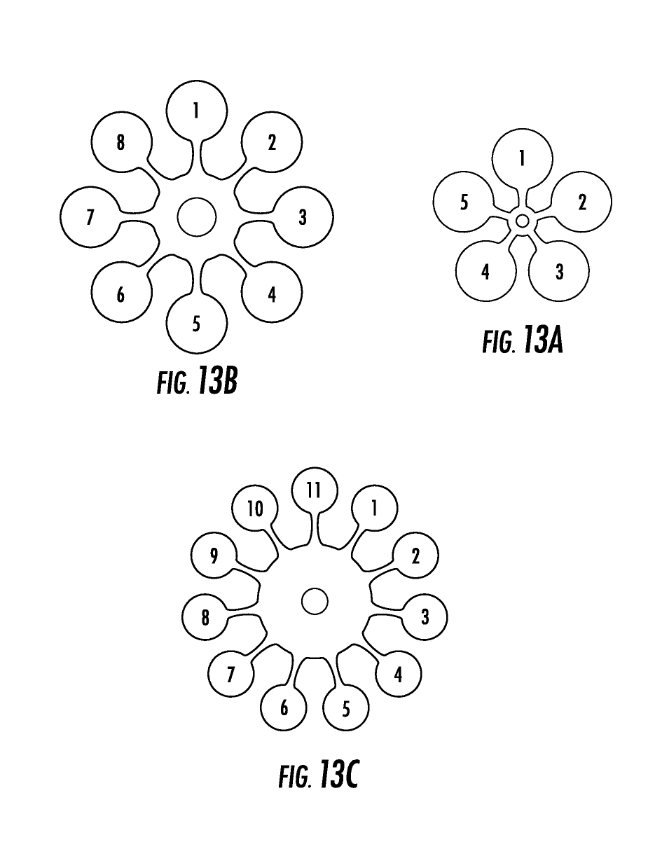

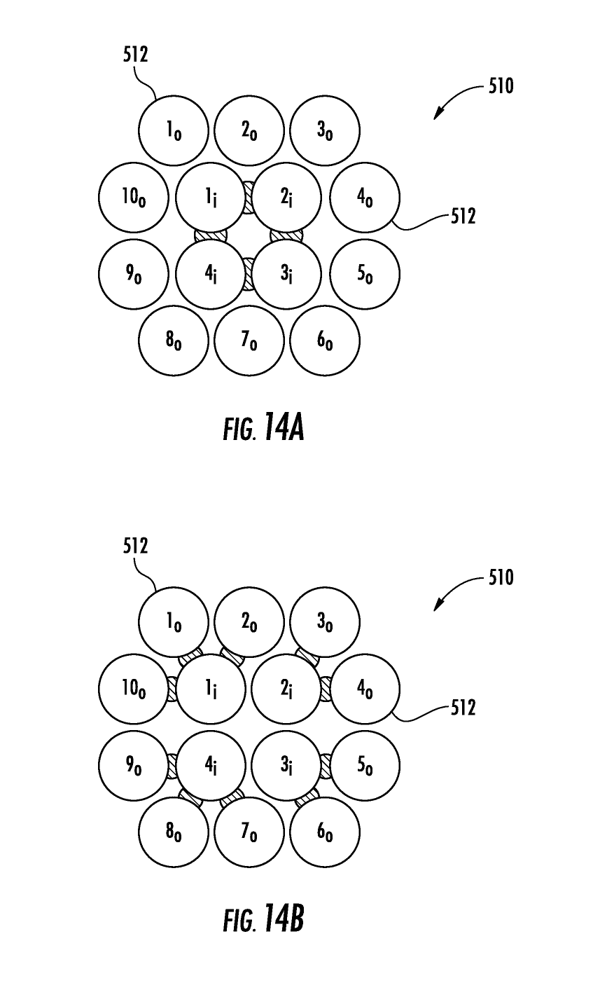

While the embodiments shown in the foregoing drawings each utilized seven optical fiber units, one skilled in the art will appreciate that a greater or lesser number of optical fiber units may be provided as needed for a particular application. In addition, one skilled in the art will appreciate that a tension member could be used instead of an optical fiber unit as the central unit. In addition, the number of outer units can be changed in accordance with the diameter of the central member or the length or width of the bonding part. When utilizing central units of various size, the outer units can be arranged as shown in FIGS. 13A-13C.

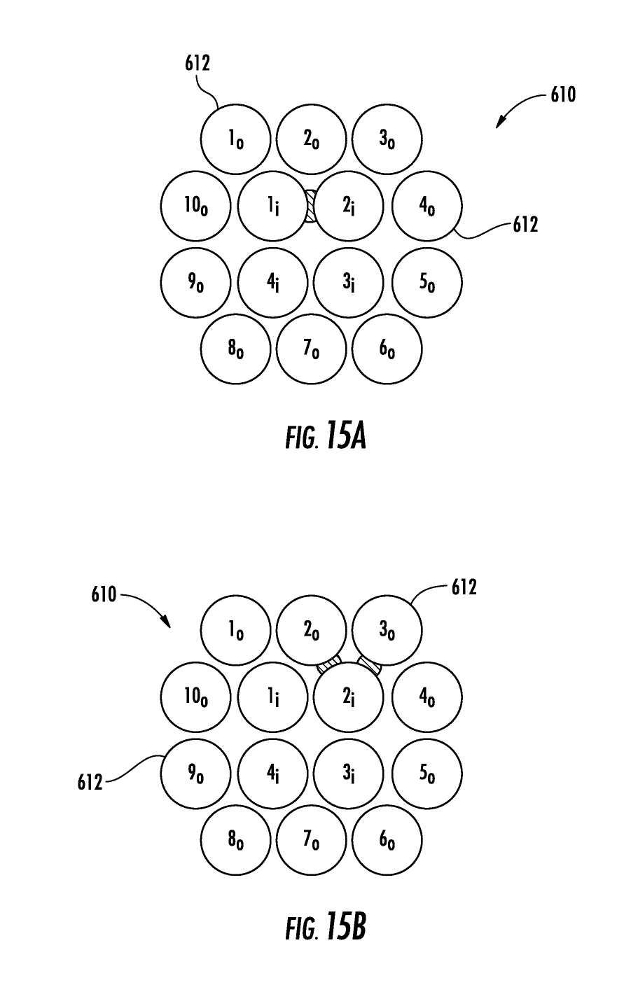

FIGS. 14A and 14B illustrate a trunk cable 510 utilizing a total of fourteen optical fiber units 512. As can be seen, the units 512 are organized into a central bundle having four units (designated through 4) surrounded by ten outer units (designated 10 through 100. Units of the central bundle may be interconnected to each other at one bonding location (as shown in FIG. 14A), whereas the outer units may be interconnected to the central bundle at the next location (as shown in FIG. 14B). The pattern repeats along the length of the trunk cable with the bonding locations spaced by a predetermined axial pitch.

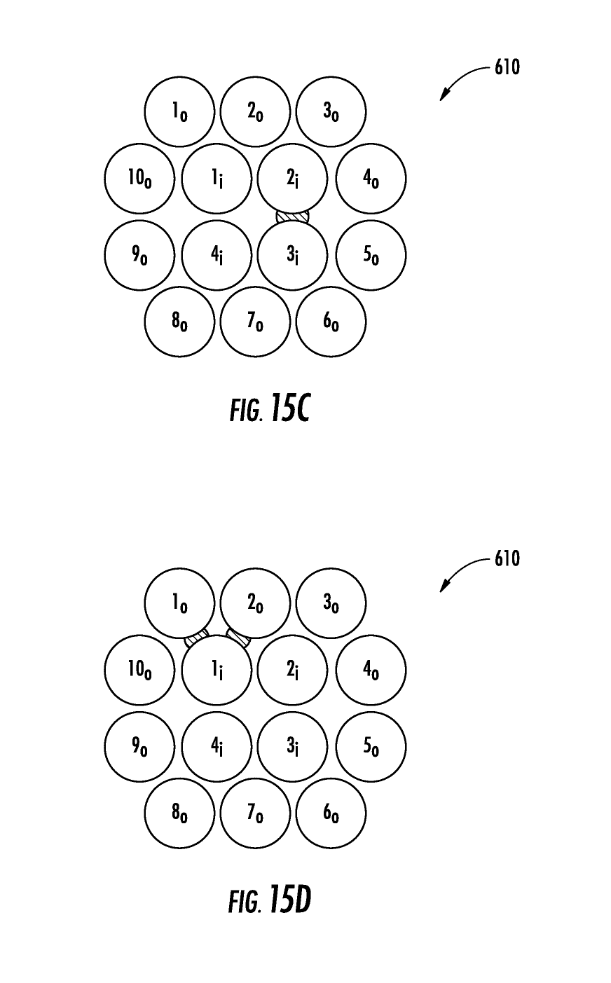

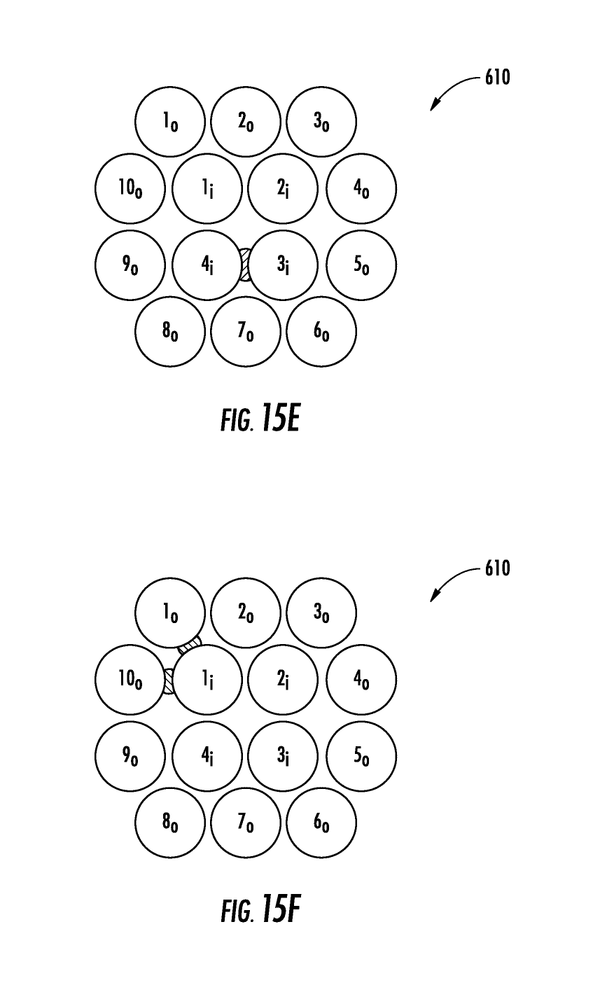

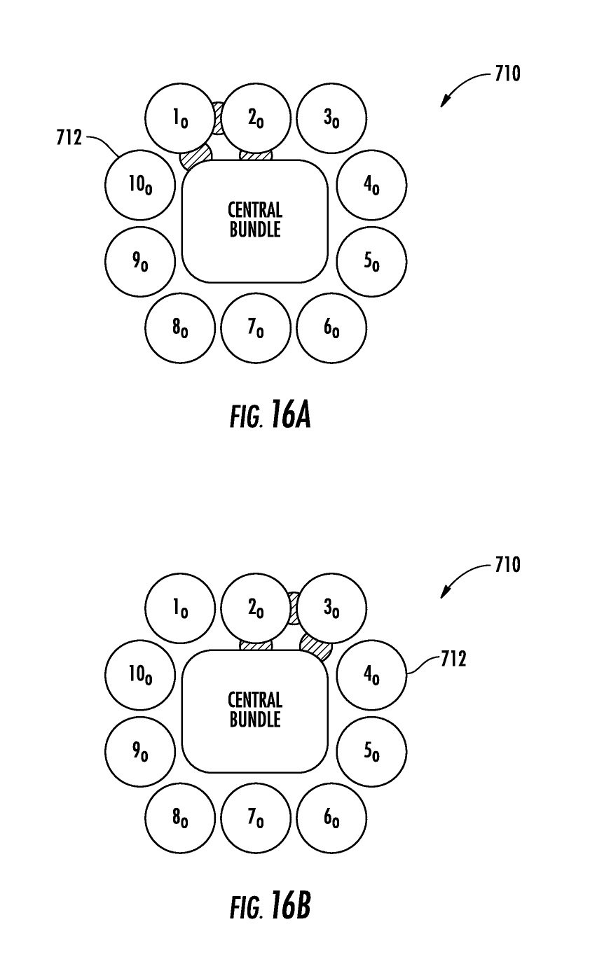

FIGS. 15A through 15F illustrate a trunk cable 610 in accordance with an alternative embodiment, also utilizing fourteen optical fiber units 612. In this case, a different combination of central bundle units are interconnected at every second bonding location. At the intervening bonding locations, any two or more outer units can be bonded with one or more of the inner units. For example, as shown in FIG. 15A, a first pair of inner units (designated L and 2) may be interconnected at a first bonding location. As shown in FIG. 15B, a first pair of outer units (designated 20 and 30 are respectively interconnected with an inner unit (designated 2). As shown in FIGS. 15C and 15E, different combinations of inner units are interconnected at the third and fifth bonding locations. Similarly, as shown in FIGS. 15D and 15F, different combinations of outer units are interconnected with inner units at the fourth and sixth bonding locations. Preferably, the interconnected combinations will repeat along the length of the trunk cable.

FIGS. 16A and 16B illustrate a trunk cable 710 in accordance with a further embodiment of the present invention. As shown, trunk cable 710 comprises a plurality of optical fiber units 712 organized into a central bundle surrounded by outer units. (The central bundle is shown collectively only for purposes of illustration.) In this case, a different combination of outer units are interconnected with the central bundle but also with each other at different bonding locations. For example, as shown in FIG. 16A, a first pair of outer units (designated 10 and 20 are interconnected with the central bundle, but also with each other at one bonding location. FIG. 16B illustrates a different bonding location, in which outer units 20 and 30 are interconnected with the central bundle and with each other. Preferably, the pattern of interconnection combinations repeats along the axial length of trunk cable 710.

It can thus be seen that the present invention provides an improved optical trunk cable having various advantages over the prior art. In particular, a trunk cable of the present invention provides exceptional bending flexibility. In addition, individual units may be easily removed from the bundle for branching purposes. The trunk cable is thin and light, having a cross-sectional area almost equal to that the multiple units. Any one of the constituent units may be easily separated from the bundle for branching.

While preferred embodiments of the invention have been shown and described, modifications and variations may be made thereto by those of ordinary skill in the art without departing from the spirit and scope of the present invention. For example, embodiments are contemplated in which the outer optical fiber units may be wound (stranded) in a helical fashion around the central unit, but the winding pitch in such embodiments will preferably be very long to allow a branching unit to be removed easily. In embodiments employing a central bundle, the central bundle may be produced by stranding optical fiber units around a single central unit. In addition, embodiments are contemplated in which bonding is done between any two (or three) optical fiber units in an intermittent fashion along the length of the trunk cable.

Furthermore, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. An optical trunk cable comprising:
a plurality of elongated optical fiber units, each of said optical fiber units having an outer jacket containing a plurality of optical fibers; and
said optical fiber units being interconnected at intermittent bonding locations along an axial length of said trunk cable to form a sheathless bundle.

2. An optical trunk cable as set forth in claim 1, wherein all of said optical fiber units are interconnected at said bonding locations.

3. An optical trunk cable as set forth in claim 2, wherein said bonding locations are spaced apart by a predetermined axial pitch.

4. An optical trunk cable as set forth in claim 1, wherein fewer than all of optical fiber units are interconnected at said bonding locations.

5. An optical trunk cable as set forth in claim 4, wherein:
a. said plurality of optical fiber units comprises at least four of said elongated optical units; and
b. a different combination of said optical fiber units are interconnected at adjacent bonding locations.

6. An optical trunk cable as set forth in claim 5, wherein at last two of said optical fiber units are interconnected at each said bonding location.

7. An optical trunk cable as set forth in claim 5, wherein said plurality of optical fiber units comprises at least seven optical fiber units with multiple outer optical fiber units being arranged around at least one inner optical fiber unit.

8. An optical trunk cable as set forth in claim 5, wherein said optical fiber units are interconnected along said axial length of said trunk cable in a repeating pattern having a predetermined axial pitch.

9. An optical trunk cable as set forth in claim 1, wherein said optical fiber units are interconnected via adhesive applied at said bonding locations.

10. An optical trunk cable as set forth in claim 1, wherein said optical fiber units are interconnected via polymeric material molded in place at said bonding locations.

11. An optical trunk cable as set forth in claim 1, wherein said outer jackets of said optical fiber units are thermally bonded together at said bonding locations.

12. An optical trunk cable as set forth in claim 1, wherein each of said optical fiber units comprises at least four of said optical fibers.

13. An optical trunk cable as set forth in claim 1, wherein said plurality of elongated optical fiber units are arranged in parallel to each other along their entire axial length.

14. A method of branching a selected optical fiber unit from an optical trunk cable, said method comprising:
a. providing an optical trunk cable comprising:
i. a plurality of elongated optical fiber units; and
ii. said optical fiber units being interconnected at intermittent bonding locations along an axial length of said trunk cable to form a sheathless bundle;
b. selecting a desired branching position along said axial length of said optical trunk cable;
c. cutting said selected optical fiber unit at a cut position spaced apart from said desired branching position to form a tail portion;
d. separating said selected optical fiber unit from interconnected other of said optical fiber units at said bonding locations between said branching position and said cut position; and
e. removing said tail portion of said selected optical fiber unit from said trunk cable for optical connection to a different optical fiber cable.

15. A method as set forth in claim 14, wherein each of said optical fiber units comprises at least four optical fibers.

16. An optical trunk cable comprising:
at least seven elongated optical fiber units; and
said optical fiber units being interconnected at intermittent bonding locations along an axial length of said trunk cable to form a sheathless bundle, wherein a different combination of less than all of said optical fiber units are interconnected at adjacent bonding locations in a repeating pattern having a predetermined axial pitch.

17. An optical trunk cable comprising:
at least seven elongated optical fiber units; and
said optical fiber units being interconnected at intermittent bonding locations along an axial length of said trunk cable to form a sheathless bundle, wherein all of said optical fiber units are interconnected at adjacent bonding locations separated by a predetermined axial pitch.

18. An optical trunk cable as set forth in claim 17, wherein each of said optical fiber units comprises at least four optical fibers.
